(19) United States
(12) Patent Application Publication
(10) Pub. No.: US 2022/0120941 A1
(43) Pub. Date: Apr. 21, 2022

(54) LIGHT FLUX CONTROLLING MEMBER, SHAPING METAL MOLD, MANUFACTURING METHOD OF LIGHT FLUX CONTROLLING MEMBER, AND MANUFACTURING METHOD OF SHAPING METAL MOLD

(71) Applicant: Enplas Corporation, Saitama (JP)

(72) Inventors: IZAWA Takahiro, Saitama (JP); OSHIMA Satoshi, Saitama (JP)

(73) Assignee: Enplas Corporation, Saitama (JP)

(21) Appl. No.: 17/500,295

(22) Filed: Oct. 13, 2021

(30) Foreign Application Priority Data
Oct. 16, 2020 (JP) 2020-174791

(51) Int. Cl. G02B 3/08; G02B 3/00; B29D 11/00

(52) U.S. Cl. CPC G02B 3/08; G02B 3/0081; B29K 2995/0094; B29D 11/0048; G02B 2003/0093; B29D 11/00019

(57) ABSTRACT

A light flux controlling member includes: a vortex surface having a continuous or stepwise spiral shape; and a plurality of ridges radially disposed around a center of a spiral in the vortex surface. The height of the plurality of ridges decreases toward the center.

### CROSS REFERENCE TO RELATED APPLICATIONS

This application is entitled to and claims the benefit of Japanese Patent Application No. 2020-174791, filed on Oct. 16, 2020, the disclosure of which including the specification, drawings and abstract is incorporated herein by reference in its entirety.

### TECHNICAL FIELD

The present invention relates to a light flux controlling member, a shaping metal mold, a manufacturing method of a light flux controlling member and a manufacturing method of a shaping metal mold.

### BACKGROUND ART

In recent years, communication devices and systems equipped with multimode fibers have been used to transmit and receive large amounts of data at high speeds using optical communications. Multimode fibers have a larger diameter of the core through which light passes than single-mode fibers, and thus can transmit more light. However, as a large number of modes of light pass through, the propagation speed of light in each mode differs, causing differential modal dispersion (DMD), which degrades the optical waveform. This problem becomes particularly problematic in multimode fibers when the refractive index distribution at the center portion of the core is unstable.

As a means to improve this problem, the use of optical elements called vortex lenses or vortex phase plates is known. A vortex lens (vortex phase plate) is an optical element (light flux control member) with a surface (vortex surface) having a continuous or stepwise spiral shape. When light with a Gaussian distribution with a high intensity at the center portion is passed through a vortex lens, it is converted into light with a ring-shaped intensity distribution, with a marked decrease in intensity at the center portion.

When the light converted into a ring-shaped intensity distribution by the vortex lens is injected into the multimode fiber, the light can be suppressed from directly entering the center portion of the core, thus suppressing the effect of the refractive index distribution in the center portion of the core, and the light of higher-order modes becomes the main light, thus suppressing the degradation of the optical waveform.

For example, PTL 1 discloses an optical component equipped with a lens in which a vortex shape is formed. According to PTL 1, the optical component could be used to inject light into a multimode fiber with a ring-shaped intensity distribution in which the intensity at the center portion is reduced. In addition, it is said that optical axis adjustment was made easier by forming a vortex shape on the surface of the lens and integrating these components.

PTL 2 discloses an optical communication device equipped with an optical transmitter with a transmitter-side vortex optical element disposed between a light source and a multimode fiber, and an optical receiver with a receiver-side vortex optical element disposed between a multimode fiber and a light receiving element. According to PTL 2, both suppression of DMD and improvement of light beam receiving efficiency have been achieved by providing the optical transmitter and optical receiver with a vortex optical element that imparts a phase difference in the opposite direction to the direction of rotation of the light wavefront, respectively.

### CITATION LIST

### Patent Literature

### PTL 1

### WO2018/163936

### PTL 2

### WO2018/198511

### SUMMARY OF INVENTION

### Technical Problem

When optical elements, such as lenses, are manufactured using a metal mold, the surface on which the optical surface of the metal mold is formed is generally formed by cutting in concentric circles around the portion corresponding to the optical axis of the optical surface. Therefore, the inventor formed the surface to form the vortex surface of the metal mold for forming the vortex lens (hereinafter referred to as the “vortex forming surface”) by cutting in concentric circles around the center of the spiral. When a vortex lens was manufactured using the metal mold obtained in this way, circular processing marks 11 were formed both in the center portion and on the outer periphery portion of the vortex surface 10, as shown in FIG. 1A. In addition, as shown in FIG. 1b, stress was concentrated when machining the center of the vortex forming surface 12, resulting in the formation of a large spiral-shaped processing mark (crush) 13 in the center of the vortex forming surface 12. As a result, a large spiral-shaped processing mark (crush) was also formed in the center of the vortex surface (not shown in FIG. 1A).

If large circular or spiral processing marks (crushes) are present in the center of the vortex surface as described above, a lot of stray light is generated when light is incident on the vortex surface. A possible solution to this problem is to leave the center of the vortex forming surface flat instead of processing it into a spiral shape. However, a vortex lens with the center of the vortex surface as a flat surface cannot form a ring-shaped intensity distribution of light because high intensity light passes through the flat part, and thus cannot perform the desired function.

In consideration of the above-mentioned circumstances, an object of the present invention is to provide a light flux controlling member including a vortex surface that can suppress generation of stray light due to processing marks in a center portion of a vortex surface. In addition, another object of the present invention is to provide a metal mold for shaping the above-mentioned light flux controlling member, a manufacturing method of the above-mentioned light flux controlling member, and a manufacturing method of the above-mentioned shaping metal mold.

### Solution to Problem

A light flux controlling member according to an embodiment of the present invention includes: a vortex surface having a continuous or stepwise spiral shape; and a plurality of ridges radially disposed around a center of a spiral in the vortex surface. A height of the plurality of ridges decreases toward the center.

A light flux controlling member according to an embodiment of the present invention that is shaped using a shaping metal mold including a vortex shaping surface having a continuous or stepwise spiral shape. The vortex shaping surface includes a plurality of grooves radially disposed around a center of a spiral and having a depth that decreases toward the center.

A shaping metal mold according to an embodiment of the present invention includes: a vortex shaping surface having a continuous or stepwise spiral shape; and a plurality of grooves radially disposed around a center of a spiral in the vortex shaping surface and having a depth that decreases toward the center.

A manufacturing method of a light flux controlling member according to an embodiment of the present invention includes: injecting a shaping material into a cavity including a surface including the vortex shaping surface of the shaping metal mold; and solidifying the shaping material in the cavity.

A manufacturing method of a shaping metal mold according to an embodiment of the present invention includes: preparing a metal mold base material; and forming a vortex shaping surface having a continuous or stepwise spiral shape through radial cutting around a predetermined point of the metal mold base material as a center.

### Advantageous Effects of Invention

The present invention can provide a light flux controlling member including a vortex surface that can suppress generation of stray light due to processing marks in the center portion of the vortex surface.

### BRIEF DESCRIPTION OF DRAWINGS

FIG. 1A is a schematic view illustrating a vortex surface of a vortex lens manufactured using a concentrically cut vortex shaping surface, and FIG. 1B is a photograph of the concentrically cut vortex shaping surface;

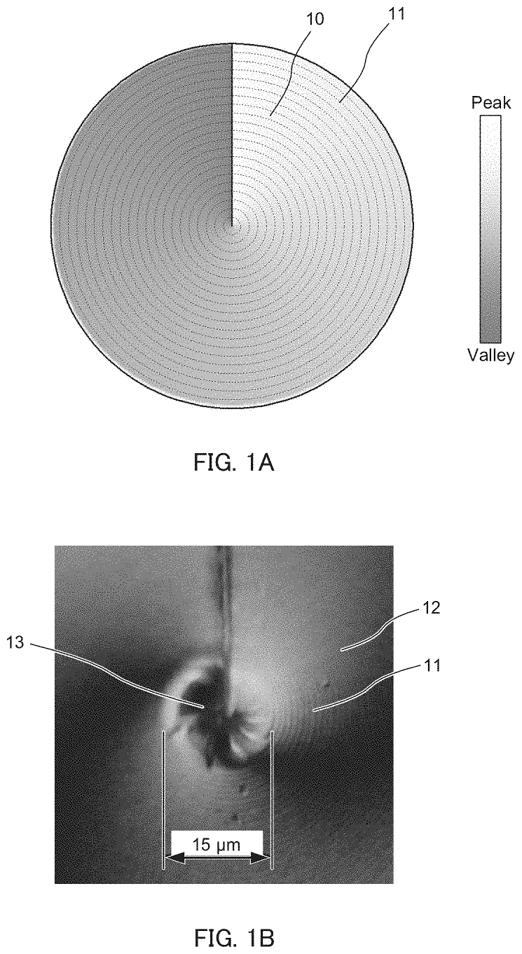

FIG. 2A is a plan view of a shaping metal mold according to an embodiment of the present invention, and FIG. 2B is a sectional view of the shaping metal mold;

FIG. 3A is a schematic plan view illustrating an exemplary ideal vortex surface, FIG. 3B is a schematic view illustrating a state where a shaping surface is processed by a common processing method, FIG. 3C is a schematic plan view illustrating a vortex surface shaped using a metal mold manufactured by the method illustrated in FIG. 3B, FIG. 3D is a schematic view illustrating a state where a shaping surface is processed by a processing method according to the embodiment of the present invention, and FIG. 3E is a schematic plan view illustrating a vortex surface shaped using a metal mold manufactured by the method illustrated in FIG. 3D;

FIG. 4 is a photograph of radially cut vortex shaping surface according to the embodiment of the present invention;

FIG. 5 is a flowchart of a manufacturing method of a light flux controlling member according to the embodiment of the present invention;

FIG. 6A is a perspective view of the light flux controlling member according to the embodiment, FIG. 6B is a plan view of the light flux controlling member, and FIG. 6C is a side view of the light flux controlling member;

FIG. 7 is a graph illustrating a variation of the height of the vortex surface with respect to the position in the x direction; and

FIG. 8 is a graph illustrating a variation of the height of the vortex surface with respect to the position in the y direction.

### DESCRIPTION OF EMBODIMENTS

An embodiment of the present invention is elaborated below with reference to the accompanying drawings.

### Shaping Metal Mold and Manufacturing Method of the Same

First, shaping metal mold 100 according to an embodiment of the present invention is described. As described later, shaping metal mold 100 is used for manufacturing light flux controlling member 200 including vortex surface 210.

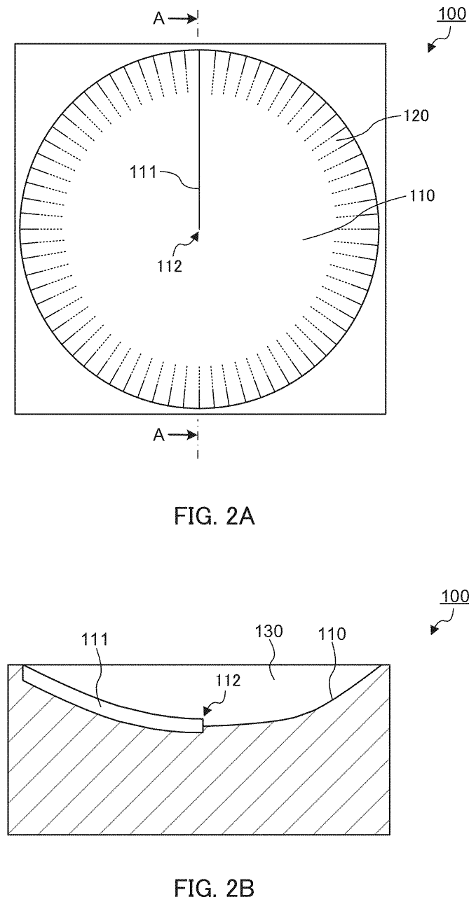

FIGS. 2A and 2B illustrate a configuration of shaping metal mold 100. FIGS. 2A and 2B illustrate only a piece including vortex shaping surface 110 of shaping metal mold 100. In practice, cavity 130 is formed in combination with another piece. FIG. 2A is a plan view of shaping metal mold 100, and FIG. 2B is a sectional view taken along line A-A of FIG. 2A.

As illustrated in FIG. 2A and FIG. 2B, shaping metal mold 100 includes vortex shaping surface 110, a plurality of grooves 120, and cavity 130.

Vortex shaping surface 110 is a surface for shaping vortex surface 210 of light flux controlling member 200. As described later, vortex surface 210 of light flux controlling member 200 has a continuous or stepwise spiral shape. Vortex shaping surface 110 has a shape that is complementary to vortex surface 210, and has a continuous or stepwise spiral shape.

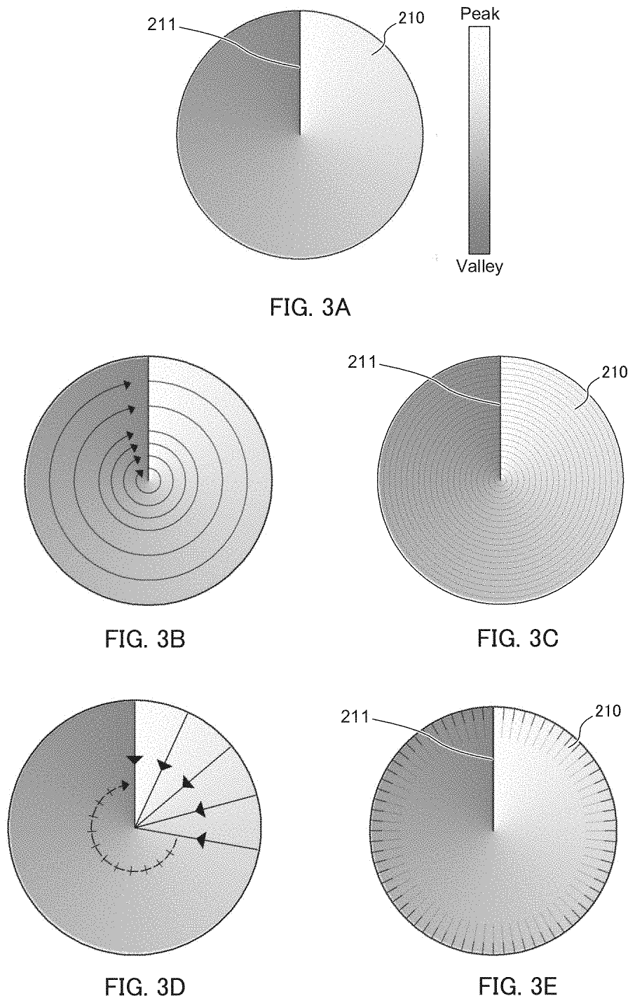

As described later, vortex surface 210 of light flux controlling member 200 has step 211 of the highest portion and the lowest portion in vortex surface 210 (see FIG. 3A). The number of steps 211 is set in accordance with charge number m_{c} (described later) that is determined based on wavelength λ of the light to be used and phase difference Δφ to be provided. As illustrated in FIG. 2B, vortex shaping surface 110 includes step 111 of the highest portion and the lowest portion in vortex shaping surface 110, which corresponds to vortex surface 210 of light flux controlling member 200. Step 111 extends from center 112 to the outer edge of the vortex shaping surface 110. The height of step 111 is set in accordance with phase difference Δφ to be provided, and is, for example, 1 μm to 10 μm.

FIG. 3A is a schematic plan view illustrating an exemplary ideal vortex surface 210. This drawing also illustrates the height of each point in vortex surface 210 by coloring it such that the larger the height, the closer to white, while the smaller the height, the closer to the black. As illustrated in FIG. 3A, it is preferable that in vortex surface 210, the parts between steps 211 in the circumferential direction be gently contiguous surfaces, and is ideally a mirror surface.

As illustrated in FIG. 3B, when vortex shaping surface 110 of shaping metal mold 100 is formed by performing a concentric cutting process as with a known common processing method, annular processing marks are formed. As a result, annular processing marks are formed also in vortex surface 210 of light flux controlling member 200 as illustrated in FIG. 3C. Such processing marks are formed not only in the outer periphery portion but also in a center portion in vortex surface 210.

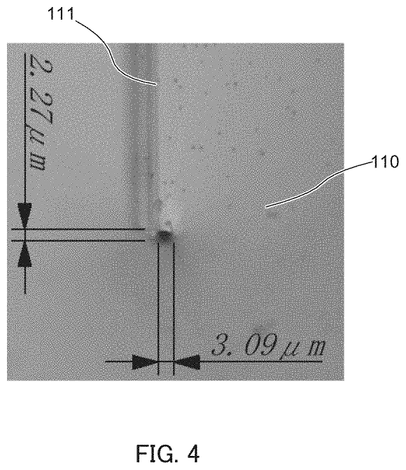

In the present embodiment, vortex shaping surface 110 of shaping metal mold 100 is formed by performing a radial cutting process as illustrated in FIG. 3D. In this case, radial processing marks may be formed in the outer periphery portion of vortex shaping surface 110. On the other hand, in the center portion of vortex shaping surface 110, the processing region overlaps and the same region is repeatedly processed, and thus, the depth of the processing groove is very small, or eliminated. As a result, as illustrated in FIG. 3E, almost no processing mark 11 is formed in at least the center portion of vortex surface 210 of light flux controlling member 200. FIG. 4 is a photograph of radially cut vortex shaping surface 110.

As described above, in shaping metal mold 100 according to the present embodiment, the plurality of grooves 120 is radially disposed around the center of the spiral of vortex shaping surface 110 (center 112 of vortex shaping surface 110) as illustrated in FIG. 2A. As it comes closer to the center of the spiral, each of the plurality of grooves 120 reduces its distance from the adjacent groove 120, and finally overlaps the adjacent groove 120. As adjacent grooves 120 overlap each other, the height of the ridge (ridgeline) therebetween decreases, and thus the depth of groove 120 decreases toward the center. Thus, the region around center 112 of vortex shaping surface 110 is a substantially mirror surface.

As described above, vortex shaping surface 110 of shaping metal mold 100 is formed by performing a radial cutting process, and thus a substantially mirror surface can be formed in the region around center 112 of vortex shaping surface 110. In addition, vortex shaping surface 110 is processed without continuously pressing the cutting tool against the center portion of vortex shaping surface 110, and thus formation of large processing marks (crushes) in the center portion of vortex shaping surface 12 can be suppressed.

It is only necessary that the plurality of grooves 120 is disposed such that the irregularity in the center portion of vortex shaping surface 110 is small (e.g., the height of the irregularity is equal to or smaller than 3 nm, and preferably, a substantially mirror surface is formed). The plurality of grooves 120 may be disposed at a regular angular interval, or at an irregular angular interval. In the present embodiment, the plurality of grooves 120 is disposed at a regular angular interval. From the viewpoint of reducing the size of the irregularity in the center portion of vortex shaping surface 110, it is preferable that in plan view, the plurality of grooves 120 is disposed such that the angle between grooves 120 adjacent to each other is 0.5° or smaller. More preferably, it is disposed such that the angle between grooves 120 adjacent to each other is 0.05° or smaller from the viewpoint of reducing the size of the irregularity not only in the center portion of vortex shaping surface 110 but also in the outer periphery portion. The lower limit value of the angle between grooves 120 adjacent to each other is not limited, but is, for example, 0.01° or greater from a view point of the efficiency of the process.

The cross-sectional shape perpendicular to the extending direction of groove 120 is not limited, and is, for example, a spherical cap shape (including a semicircular shape), or a rectangular shape. In the present embodiment, the cross-sectional shape of groove 120 is a spherical cap shape. More specifically, in the outer periphery portion of vortex shaping surface 110, the cross-sectional shape of groove 120 is a substantially semicircular shape, and the upper part of groove 120, and the depth of the groove 120, are reduced as they come closer to the center portion of vortex shaping surface 110.

The width of groove 120 is not limited, but preferably is 1 μm to 5 μm from the viewpoint of reducing the size of the irregularity in the center portion of vortex shaping surface 110.

The depth of groove 120 is not limited, but the smaller the depth, the more preferable. From the viewpoint of suppressing the generation of stray light around the center portion of vortex surface 210 of light flux controlling member 200, the depth of groove 120 around the center portion of vortex shaping surface 110 is preferably 3 nm or smaller, more preferably, 0 nm.

In addition, from the viewpoint of reducing the irregularity in the center portion of vortex shaping surface 110, the depth of groove 120 in the outer periphery portion of vortex shaping surface 110 is preferably 30 nm or smaller.

The manufacturing method of shaping metal mold 100 according to the present embodiment is not limited. For example, shaping metal mold 100 according to the present embodiment can be manufactured by (1) preparing the metal mold base material, and (2) forming spiral vortex shaping surface 110 by radially cutting the metal mold base material around a predetermined point of the metal mold base material as the center.

The material of the metal mold base material is not limited, and may be appropriately selected from publicly known materials. Examples of the metal mold base material include steel materials, zinc alloys, and aluminum alloys. Preferably, the metal mold base material includes a steel material from a view point of durability.

The cutting tool is also not limited, and may be appropriately selected from publicly known metal mold processing tools.

In the present embodiment, when forming vortex shaping surface 110 by means of cutting, the point of the center of the spiral is set in one main surface of the metal mold base material, and it is radially cut toward the center. In this manner, the plurality of grooves 120 radially disposed toward the center of the spiral is formed. In addition, in this case, the cutting is performed by changing the height of the tip of the tool such that the depth of a groove adjacent to one groove 120 in the spiral rotational direction becomes deeper. For example, in the case where the groove is sequentially cut clockwise such that the angle between adjacent grooves is 0.2° in plan view, the cutting is performed in such manner as to form a groove deeper than one groove that has been formed, at a position proceeded clockwise by 0.2° from the one groove that has been formed. By continuously performing this process one round, a continuous or stepwise spiral shape is formed in one main surface of the metal mold base material. The spiral direction may be arbitrarily set, and it is only necessary that the cutting is performed by changing the height of the tip of the tool in accordance with the above-mentioned rotational direction.

Note that the manufacturing method of the shaping metal mold according to the embodiment of the present invention may also be performed by setting the point of the center of the spiral in one main surface of the metal mold base material, and radially cutting it from the center.

As described above, vortex shaping surface 110 of shaping metal mold 100 is formed by performing a radial cutting process, and thus a substantially mirror surface can be formed in the region around center 112 of vortex shaping surface 110. In addition, vortex shaping surface 110 is processed without continuously pressing the cutting tool against the center portion of vortex shaping surface 110, and thus formation of large processing marks (crushes) in the center portion of vortex shaping surface 12 can be suppressed.

### Light Flux Controlling Member and Manufacturing Method of the Same

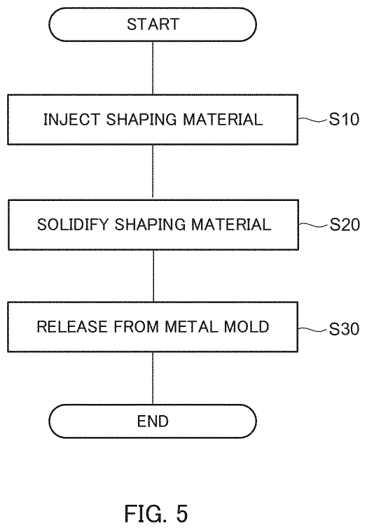

FIG. 5 is a flowchart of a manufacturing method of light flux controlling member 200 according to the present embodiment.

As illustrated in FIG. 5, light flux controlling member 200 according to the present embodiment includes, for example, (1) a step of injecting a shaping material into cavity 130 of shaping metal mold 100 (step S10), (2) a step of solidifying the shaping material in cavity 130 (step S20), and (3) a step of releasing and removing the solidified shaping material from the shaping metal mold (step S30). Each step is described below.

First, the shaping material is injected into cavity 130 of shaping metal mold 100 (step S10). For example, the shaping metal mold 100, used as a fixed side metal mold, is clamped with a movable side metal mold disposed opposite to the fixed side metal mold, and then the shaping material is injected from a shaping material inlet.

In the present embodiment, resin materials may be used as the shaping material. The type of the resin material is appropriately selected from materials that are optically transparent to the light used. Examples of the resin material include polymethylmethacrylate (PMMA), polycarbonate (PC), epoxy resin (EP), modified polyphenylene ether (m-PPE), cycloolefin polymer (COP), and cyclic olefin copolymer (COC).

Next, the shaping material injected in cavity 130 is solidified (step S20). For example, in the case where a thermoplastic resin is injected in cavity 130, it suffices to cool and solidify the thermoplastic resin. In addition, in the case where a thermosetting resin is injected in cavity 130, it suffices to heat and solidify (cure) the resin in cavity 130.

Finally, the shaping material solidified at step S20 is released and removed from the shaping metal mold (step S30).

Through the above-mentioned procedure, light flux controlling member 200 including vortex surface 210 with the inverted shape of vortex shaping surface 110 of shaping metal mold 100 can be manufactured. Light flux controlling member 200 is described below.

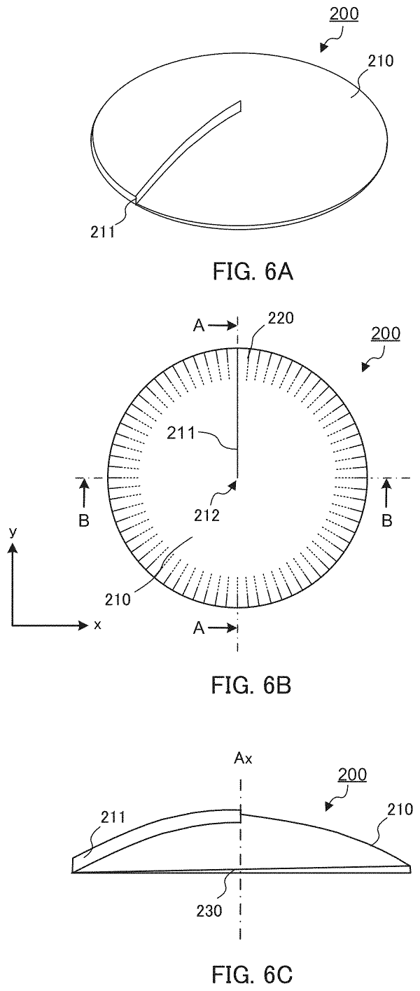

FIGS. 6A to 6C illustrate light flux controlling member 200 according to the present embodiment. FIG. 6A is a perspective view of light flux controlling member 200, FIG. 6B is a plan view of light flux controlling member 200, and FIG. 6C is a side view of light flux controlling member 200.

As illustrated in FIGS. 6A to 6C, light flux controlling member 200 includes vortex surface 210, a plurality of ridges 220, and incidence surface 230. Note that in FIG. 6A and FIG. 6C, ridge 220 is omitted for the sake of convenience. In addition, in FIG. 6C, Ax represents the optical axis.

Vortex surface 210 is a surface having a continuous or stepwise spiral shape. Light passing through vortex surface 210 is converted into light with a ring-shaped intensity distribution and a phase difference in the circumferential direction. In FIG. 6B, vortex surface 210 has a structure whose height gradually decreases as it goes clockwise.

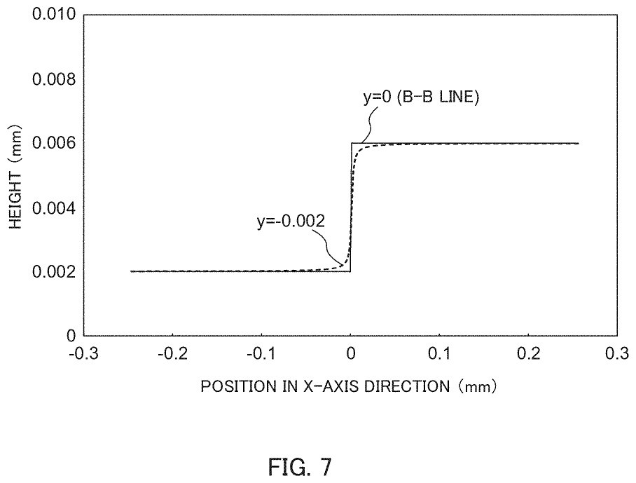

FIG. 7 is a graph illustrating a variation of the height of vortex surface 210 with respect to the position in the x direction in a y=0 cross-section (line B-B cross-section) and a y=−0.002 mm cross-section in the XY coordinate system (with its origin at center 212 of vortex surface 210) illustrated in FIG. 6B. The solid line indicates a y=0 cross-section (line B-B cross-section), and the broken line indicates a y=−0.002 mm cross-section.

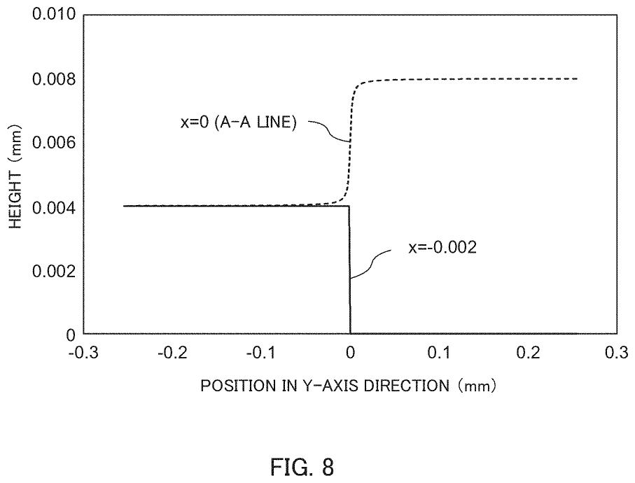

Likewise, FIG. 8 is a graph illustrating a variation of the height of vortex surface 210 with respect to the position in the y direction in an x=0 cross-section (line A-A cross-section) and an x=−0.002 mm cross-section in the same XY coordinate system. The solid line indicates an x=0 cross-section (line A-A cross-section), and the broken line indicates x=−0.002 mm cross-section.

As illustrated in FIGS. 6A to 6C, light flux controlling member 200 includes step 211 of the highest portion and the lowest portion in vortex surface 210. The phase difference ΔΦ given to light passing through vortex surface 210 is determined by the following Equation (1).

ΔΦ=2π×m_{c}×Δn×d/λ (1)

where m_{c} represents the charge number that is the number of repetitions of the shape of step 211 in one round in vortex surface 210, d represents the height of the step, λ represents the wavelength of light, and Δn represents the refractive index difference at light wavelength λ between the material of light flux controlling member 200 and the surrounding medium (e.g., air). When phase difference ΔΦ is 2π×m (m is an integer), light having a ring-shaped intensity distribution with high axis symmetry with respect to the optical axis is obtained.

The number (charge number m_{c}) and height d of step 211 is appropriately set in accordance with phase difference ΔΦ to be given to light passing through vortex surface 210. In the present embodiment, the number of step 211 is 1 (see FIG. 6A), and the height of step 211 is 8 μm (see FIG. 8).

The plurality of ridges 220 is a pattern where the plurality of grooves 120 of shaping metal mold 100 is transferred. As illustrated in FIG. 6B, the plurality of ridges 220 is radially disposed from the center of the spiral in vortex surface 210. Therefore, in the plurality of ridges 220, the distance from the adjacent ridge decreases toward the center of the spiral, and finally they overlap each other. As such, the depth of each groove between adjacent ridges decreases toward the center of the spiral. Accordingly, the height of ridge 220 decreases toward the center. In this manner, the portion around the center of vortex surface 210 is a substantially mirror surface. The “height of ridge 220” does not mean the absolute height of ridge 220 (e.g., the height with respect to incidence surface 230), but means the height with respect to the bottom of the groove on both sides of ridge 220.

It suffices that the plurality of ridges 220 is disposed in such a manner as to reduce the size of the irregularity in the center portion of vortex surface 210 (e.g., the height of the irregularity is equal to or smaller than 3 nm, and preferably, a substantially mirror surface is formed). The plurality of ridges 220 may be disposed at a regular angular interval, or at an irregular angular interval. In the present embodiment, the plurality of ridges 220 is disposed at a regular angular interval. From the viewpoint of reducing the size of the irregularity in the center portion of vortex surface 210, it is preferable that the plurality of ridges 220 be disposed such that in plan view, the angle between ridges 220 adjacent to each other is 0.5° or smaller. Preferably, it is disposed such that the angle between ridges 220 adjacent to each other is 0.05° or smaller from the viewpoint of reducing the size of the irregularity not only in the center portion but also in the outer periphery portion of vortex surface 210. The lower limit value of the angle ridges 220 adjacent to each other is not limited, but is, for example, 0.01° or greater from a view point of the process efficiency of the metal mold.

The cross-sectional shape of ridge 220 perpendicular to the extending direction is not limited, and may be a spherical cap shape (including a semicircular shape), or a rectangular shape, for example. In the present embodiment, the cross-sectional shape of ridge 220 is a spherical cap shape. More specifically, in the outer periphery portion of vortex surface 210, the cross-sectional shape of ridge 220 is a substantially semicircular shape, and the bottom portion of ridge 220, and the height of ridge 220, are reduced as they come closer to the center portion of vortex surface 210.

The width of ridge 220 is not limited, but preferably is 1 μm to 5 μm from the viewpoint of reducing the size of irregularity in the center portion of vortex surface 210.

The height of ridge 220 is not limited, but the smaller the height, the more preferable. From the viewpoint of suppressing the generation of stray light around the center portion of vortex surface 210, the height of ridge 220 around the center portion of vortex surface 210 is preferably 3 nm or smaller, more preferably 0 nm.

### Effect

As described above, in the present embodiment, vortex shaping surface 110 of shaping metal mold 100 is formed by performing a radial cutting process, and thus a substantially mirror surface can be formed in the region around center 112 of vortex shaping surface 110. In addition, vortex shaping surface 110 is processed without continuously pressing the cutting tool against the center portion of vortex shaping surface 110, and thus formation of large processing marks (crushes) in the center portion of vortex shaping surface 12 can be suppressed. As a result, light flux controlling member 200 according to the present embodiment can suppress generation of stray light at the center portion of vortex surface 210, and can generate light with a desired ring-shaped intensity distribution.

Note that in light flux controlling member 200 according to the present embodiment, stray light may be slightly generated by the plurality of ridges 220 provided in the outer periphery portion of vortex surface 210, but its influence is small from a view point of generating light with a desired ring-shaped intensity distribution. If ridges 220 are troublesome, they may be removed through polishing. Polishing of vortex shaping surface 110 can remove the plurality of grooves 120 in the outer periphery portion of vortex shaping surface 110, but the edge (ridgeline) of step 111 may be corrupted. In addition, if a priority is given to leaving a sharp edge shape, there is a risk that groove 120 will remain only around step 111.

While light flux controlling member 200 includes one vortex surface 210 in the present embodiment, the light flux controlling member according to the embodiment of the present invention may be a lens array including a plurality of vortex surfaces 210.

### INDUSTRIAL APPLICABILITY

The present invention can provide a light flux controlling member including a vortex surface that causes less stray light. The light flux controlling member according to the embodiment of the present invention is suitable for optical communications and the like, for example.

### REFERENCE SIGNS LIST

10 Vortex surface
11 Annular processing mark
12 Vortex shaping surface
13 Spiral processing mark (crush)
100 Shaping metal mold
110 Vortex shaping surface
111 Step
112 Center of vortex shaping surface (center of spiral)
120 Groove
130 Cavity
200 Light flux controlling member
210 Vortex surface
211 Step
212 Center of vortex surface (center of spiral)
220 Ridge
230 Incidence surface

1. A light flux controlling member comprising:
a vortex surface having a continuous or stepwise spiral shape; and
a plurality of ridges radially disposed around a center of a spiral in the vortex surface,
wherein a height of the plurality of ridges decreases toward the center.

2. The light flux controlling member according to claim 1, wherein the plurality of ridges is disposed such that in plan view, an angle between ridges adjacent to each other is 0.5° or smaller.

3. A light flux controlling member shaped using a shaping metal mold including a vortex shaping surface having a continuous or stepwise spiral shape,
wherein the vortex shaping surface includes a plurality of grooves radially disposed around a center of a spiral and having a depth that decreases toward the center.

4. A shaping metal mold comprising:
a vortex shaping surface having a continuous or stepwise spiral shape; and
a plurality of grooves radially disposed around a center of a spiral in the vortex shaping surface and having a depth that decreases toward the center.

5. The shaping metal mold according to claim 4, wherein the plurality of grooves is disposed such that in plan view, an angle between grooves adjacent to each other is 0.5° or smaller.

6. A manufacturing method of a light flux controlling member, the method comprising:
injecting a shaping material into a cavity including a surface including the vortex shaping surface of the shaping metal mold according to claim 4; and
solidifying the shaping material in the cavity.

7. A manufacturing method of a light flux controlling member, the method comprising:
injecting a shaping material into a cavity including a surface including the vortex shaping surface of the shaping metal mold according to claim 5; and
solidifying the shaping material in the cavity.

8. A manufacturing method of a shaping metal mold, the method comprising:
preparing a metal mold base material; and
forming a vortex shaping surface having a continuous or stepwise spiral shape through radial cutting around a predetermined point of the metal mold base material as a center.
